(19) United States
(12) Patent Application Publication
(10) Pub. No.: US 2024/0247491 A1
(43) Pub. Date: Jul. 25, 2024

(54) SYSTEMS AND METHODS FOR HEATING ASPHALT USED IN THE MANUFACTURE OF ROOFING

(71) Applicant: TAMKO Building Products LLC, Galena, KS (US)

(72) Inventors: Jeremy Baer, Hoover, AL (US); Brian Sabatino, Northport, AL (US)

(21) Appl. No.: 18/415,369

(22) Filed: Jan. 17, 2024

Related U.S. Application Data
(60) Provisional application No. 63/481,083, filed on Jan. 23, 2023.

(51) Int. Cl. E04D 15/07; H05B 6/06; H05B 6/10

(52) U.S. Cl. CPC E04D 15/07; H05B 6/06; H05B 6/10

(57) ABSTRACT

Systems and methods for heating asphalt used in the manufacture of roofing are provided. The induction heating system may comprise a pipe comprising an opening configured to facilitate movement of an asphalt used in the manufacture of roofing through the opening, an asphalt conveyance system, and an induction heater. The induction heater may comprise a plurality of induction heating coils, an electronic oscillator coupled to ends of the plurality of induction heating coils, and a power supply, causing the electronic oscillator to pass a high frequency alternating current through the plurality of induction heating coils, generating an electromagnetic field around the plurality of induction heating coils. The electromagnetic field may be configured to heat the pipe through Joule heating, imparting thermal energy to the asphalt used in the manufacture of roofing within the opening of the pipe, heating the asphalt used in the manufacture of roofing to a desired temperature.

### CROSS-REFERENCE TO RELATED APPLICATION

The present application claims priority to U.S. Provisional Patent Application No. 63/481,083, filed Jan. 23, 2023, titled “SYSTEMS AND METHODS FOR HEATING ASPHALT USED IN THE MANUFACTURE OF ROOFING,” the disclosure of which is herein incorporated by reference in its entirety.

### TECHNICAL FIELD

Embodiments of the present disclosure relate to an induction heating system and, in particular, to an induction heating system for heating asphalt used in the manufacture of roofing.

### BACKGROUND

In the manufacture of roofing, various coating materials may be used to form an outer coating of the roofing. These materials may comprise asphalt used in the manufacture of roofing, polymer, acid modifiers; limestone, asphalt blending modifiers such as petroleum resin and wax, and/or other suitable materials for use in the manufacture of roofing. Many of these materials must be of a certain temperature and viscosity in order to properly be applied as the outer coating of the roofing. However, it is often difficult to maintain a desired and consistent temperature of these materials when the materials arrive at a coating station to be used as roofing coating while also maintaining the viscosity of the materials.

For at least these reasons, systems and methods for efficiently and accurately heating asphalt used in the manufacture of roofing is needed.

### SUMMARY

According to an object of the present disclosure, an induction heating system for heating asphalt used in the manufacture of roofing is provided. The induction heating system may comprise a pipe comprising an opening configured to facilitate movement of an asphalt used in the manufacture of roofing through the opening, an asphalt conveyance system configured to convey the asphalt used in the manufacture of roofing through the pipe, and an induction heater. The induction heater may comprise a plurality of induction heating coils, wherein each of the plurality of induction heating coils is positioned around a circumference of the pipe, an electronic oscillator coupled to ends of the plurality of induction heating coils, and a power supply configured to supply power to the electronic oscillator, causing the electronic oscillator to pass a high frequency alternating current through the plurality of induction heating coils, generating an electromagnetic field around the plurality of induction heating coils. The electromagnetic field may be configured to heat the pipe through Joule heating, imparting thermal energy to the asphalt used in the manufacture of roofing within the opening of the pipe, heating the asphalt used in the manufacture of roofing to a desired temperature.

According to various embodiments, the plurality of induction heating coils may comprise between four and eight induction heating coils.

According to various embodiments, the plurality of induction heating coils may comprise copper.

According to various embodiments, the asphalt used in the manufacture of roofing may comprise one or more of the following: asphalt; polymer; acid modifiers; petroleum resin; wax; and limestone.

According to various embodiments, the induction heater may be configured to heat the asphalt used in the manufacture of roofing at least 3° Fahrenheit.

According to various embodiments, the induction heater may be configured to heat the asphalt used in the manufacture of roofing to approximately 460° Fahrenheit.

According to various embodiments, the induction heating system may further comprise a thermocouple configured to measure a temperature of the asphalt used in the manufacture of roofing.

According to various embodiments, the induction heater may further comprise a processor configured to, based on the temperature of the asphalt used in the manufacture of roofing, thermostatically adjust a power output of the power supply in order to adjust the temperature of the asphalt used in the manufacture of roofing.

According to various embodiments, the induction heating system may further comprise an asphalt applicator configured to apply the asphalt used in the manufacture of roofing to one or more roofing materials.

According to various embodiments, the asphalt applicator may be positioned along the pipe, downstream from the induction heater.

According to an object of the present disclosure, a method for heating asphalt used in the manufacture of roofing is provided. The method may comprise conveying, using an asphalt conveyance system, asphalt used in the manufacture of roofing through a pipe, wherein the pipe may comprise an opening configured to facilitate movement of the asphalt used in the manufacture of roofing through the opening. The method may further comprise heating the pipe using an induction heater, wherein the induction heater may comprise a plurality of induction heating coils, wherein each of the plurality of induction heating coils is positioned around a circumference of the pipe, an electronic oscillator coupled to ends of the plurality of induction heating coils, and a power supply configured to supply power to the electronic oscillator, causing the electronic oscillator to pass a high frequency alternating current through the plurality of induction heating coils, generating an electromagnetic field around the plurality of induction heating coils. The electromagnetic field may be configured to heat the pipe through Joule heating. The method may further comprise heating the asphalt used in the manufacture of roofing to a desired temperature by imparting thermal energy from the pipe to the asphalt used in the manufacture of roofing within the opening of the pipe.

According to various embodiments, the plurality of induction heating coils may comprise between four and eight induction heating coils.

According to various embodiments, the plurality of induction heating coils may comprise copper.

According to various embodiments, the asphalt used in the manufacture of roofing may comprise one or more of the following: asphalt; polymer; acid modifiers; petroleum resin; wax; and limestone.

According to various embodiments, heating the asphalt used in the manufacture of roofing may comprise heating the asphalt used in the manufacture of roofing at least 3° Fahrenheit.

According to various embodiments, heating the asphalt used in the manufacture of roofing may comprise heating the asphalt used in the manufacture of roofing to approximately 460° Fahrenheit.

According to various embodiments, the method may further comprise measuring a temperature of the asphalt used in the manufacture of roofing using a thermocouple.

According to various embodiments, the method may further comprise, using a processor, based on the temperature of the asphalt used in the manufacture of roofing, thermostatically adjusting a power output of the power supply in order to adjust the temperature of the asphalt used in the manufacture of roofing.

According to various embodiments, the method may further comprise applying, using an asphalt applicator, the asphalt used in the manufacture of roofing to one or more roofing materials.

According to various embodiments, the asphalt applicator may be positioned along the pipe, downstream from the induction heater.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

In the drawings:

FIG. 1 illustrates a plan view of an induction heating system for heating asphalt used in the manufacture of roofing, according to an exemplary embodiment of the present disclosure;

FIG. 2 illustrates an elevation view of an induction heating system for heating asphalt used in the manufacture of roofing, according to an exemplary embodiment of the present disclosure;

FIG. 3 illustrates a perspective view of an induction heating unit of an induction heating system for heating asphalt used in the manufacture of roofing, according to an exemplary embodiment of the present disclosure;

FIG. 4 illustrates a pipe surrounded by induction heating coils, according to an exemplary embodiment of the present disclosure;

FIG. 5 illustrates a method for heating asphalt used in the manufacture of roofing, according to an exemplary embodiment of the present disclosure; and

FIG. 6 illustrates example elements of a computing device, according to an exemplary embodiment of the present disclosure.

FIGS. 7A-7B illustrate a plan view of an induction heater equipment, wherein the limestone and coating are mixed upstream of the induction heater and pass through to the coater as a slurry.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

An “electronic device” or a “computing device” refers to a device that comprises a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the terms “about” and “approximately” are understood as within a range of normal tolerance in the art, for example within 2 standard deviations of the mean. “About” and “approximately” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the terms “about” and “approximately”.

Hereinafter, embodiments disclosed in this specification will be described in detail with reference to the accompanying drawings, and the same or similar elements will be given the same reference symbols regardless of drawing numbers, and redundant description thereof will be omitted. In addition, a detailed description of well-known features or functions will be ruled out in order not to unnecessarily obscure the gist of the present disclosure.

In the following description, the terms “module” and “unit” for referring to elements are assigned and used interchangeably in consideration of convenience of explanation, and thus, the terms per se do not necessarily have different meanings or functions. Further, in describing the embodiments disclosed in the present specification, when it is determined that a detailed description of a related publicly known technology may obscure the gist of the embodiments disclosed in the present specification, the detailed description thereof will be omitted. In addition, the accompanying drawings are used to help easily understand the embodiments disclosed in this specification, the technical idea disclosed in this specification is not limited by the accompanying drawings, and it should be understood that all alterations, equivalents, and substitutes included in the spirit and scope of the present disclosure are included herein.

Although terms including ordinal numbers, that is, “first”, “second”, etc. may be used herein to describe various elements, the elements are not limited by these terms. These terms are generally only used to distinguish one element from another.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the present specification, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The present disclosure generally describes system and methods for heating asphalt used in the manufacture of roofing. According to various embodiments, the systems and methods incorporate an induction heating system on a residential or other roofing manufacturing line just prior to the application of the asphalt used in the manufacture of roofing at a coating section of the production line in the manufacture of roofing.

According to various embodiments, the induction heater may be configured to spread an inductive load across several induction heating coils in order to increase a temperature of piping through which the asphalt used in the manufacture of roofing is flowing. The increase in temperature of the piping imparts thermal energy to the asphalt used in the manufacture of roofing, causing a temperature of the asphalt used in the manufacture of roofing to increase.

The induction heater may be configured to thermostatically dial in the temperature of the asphalt used in the manufacture of roofing prior to the asphalt used in the manufacture of roofing entering the coating section, thus reducing temperature variation and viscosity variation of the asphalt used in the manufacture of roofing during coating operations. The temperature may be measured using a thermocouple and/or other suitable temperature-sensing apparatus.

The present systems and methods enable reduced operator interaction at the coating section during prolonged periods of operational disruption and maintains the circulation temperature of the asphalt used in the manufacture of roofing during extended periods of operational downtime, increasing efficiency and decreasing the number of man-hours needed for optimal functioning. Additionally, for at least these reasons, the present systems and methods reduce waste on startup, following prolonged periods of operational downtime, replace energy lost as waste heat to ambient, promoting the opportunity to reduce waste heat losses by minimizing heat insertion into the asphalt used in the manufacture of roofing remotely, prior to applying the asphalt used in the manufacture of roofing, and controls viscosity using temperature modulation, as measured by an inline viscometer in the present systems and methods.

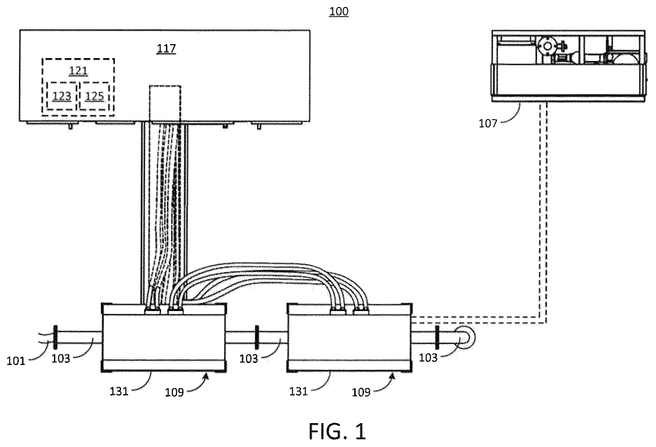

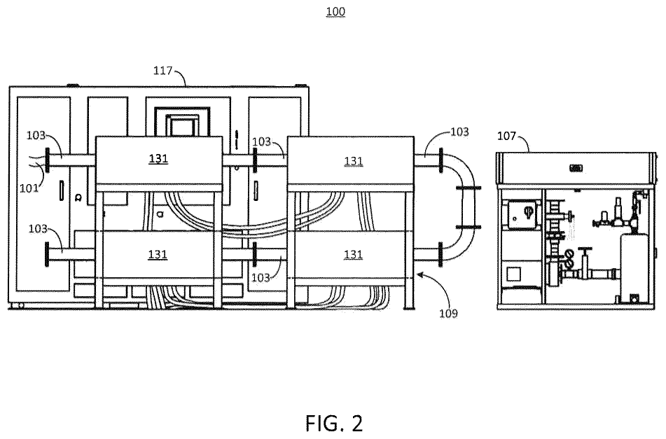

Referring now to FIGS. 1-2, a plan view (FIG. 1) and an elevation view (FIG. 2) of an induction heating system 100 for heating asphalt 101 used in the manufacture of roofing is illustratively depicted in accordance with an exemplary embodiment of the present disclosure.

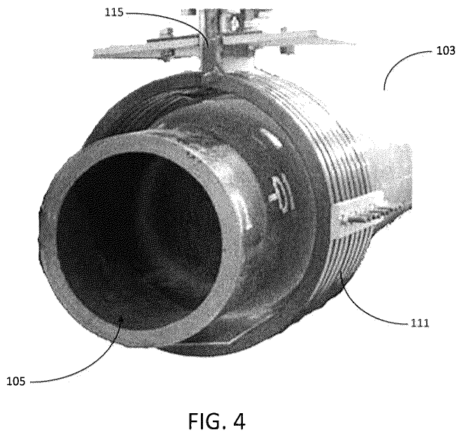

According to various embodiments, the induction heating system 100 may comprise a pipe 103. The pipe 103 may comprise an opening 105 (as shown, e.g., in FIG. 4). The opening 105 may be configured to facilitate movement of the asphalt 101 used in the manufacture of roofing through the opening 105. According to various embodiments, the asphalt 101 used in the manufacture of roofing may comprise asphalt, polymer, acid modifiers; limestone, asphalt blending modifiers such as petroleum resin and wax, and/or other suitable materials for manufacturing the asphalt 101 used in the manufacture of roofing.

According to various embodiments, the induction heating system 100 is configured to control heating of the asphalt 101 used in the manufacture of roofing, while the asphalt 101 used in the manufacture of roofing is flowing through the pipe 103 in order to minimize variation in temperature and consistency of the asphalt 101 used in the manufacture of roofing, and decrease downtime in the heating and/or cooling of the asphalt 101 used in the manufacture of roofing. According to various embodiments, the induction heating system 100 may be configured to boost the temperature of the asphalt 101 used in the manufacture of roofing by approximately 20° Fahrenheit with the use of approximately 750 amps (480V) of power.

According to various embodiments, the induction heating system 100 may comprise an asphalt conveyance system 107. The asphalt conveyance system 107 may be configured to convey the asphalt 101 used in the manufacture of roofing through the pipe 103.

According to various embodiments, the induction heating system 100 may comprise an induction heater 109. The induction heater 109 may be configured to heat the asphalt 101 used in the manufacture of roofing at least 3° Fahrenheit. According to various embodiments, the induction heater 109 may be configured to heat the asphalt 101 used in the manufacture of roofing approximately 20° Fahrenheit. According to various embodiments, the induction heater 109 may be configured to heat the asphalt 101 used in the manufacture of roofing to approximately 350° Fahrenheit to 460° Fahrenheit. It is noted, however, that, according to various embodiments, the induction heater 109 may be configured to heat the asphalt 101 used in the manufacture of roofing by greater or fewer degrees Fahrenheit and/or to a temperature greater than 460° Fahrenheit and/or less than 350° Fahrenheit.

The induction heater 109 may comprise one or more (e.g., a plurality) induction heating coils 111. Each of the induction heating coils 111 may be positioned around a circumference of the pipe 103. It is noted, however, that one or more other positions of one or more of the induction heating coils 111 may be implemented, while maintaining the spirit and functionality of the present disclosure. According to various embodiments, the one or more induction heating coils 111 may comprise between four and eight induction heating coils 111. It is noted, however, that greater or fewer numbers of induction heating coils 111 may be used, while maintaining the spirit and functionality of the present disclosure. According to various embodiments, one or more of the induction heating coils 111 may comprise copper. It is noted, however, that the one or more induction heating coils 111 may comprise one or more other suitable materials, in addition to copper or instead of copper, that enable the functionality of the induction heating coils 111. According to various embodiments, the one or more induction heating coils 111 may comprise silver soldered joints, configured to enhance conductivity and strength. It is noted, however, that one or more other suitable soldering materials may be implemented in conjunction with the one or more induction heating coils 111, while maintaining the spirit and functionality of the present disclosure.

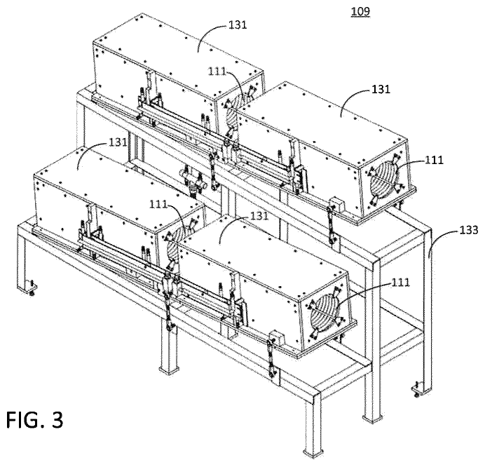

According to various embodiments, the one or more induction heating coils 111 may be housed within one or more heating coil boxes 131. The one or more heating coil boxes 131 may be configured to add rigidity to one or more components of the induction heater 109. According to various embodiments, the one or more heating coil boxes 131 may be isolated from, or in electronic communication with, one or more other heating coil boxes 131. The one or more heating coil boxes 131 may be positioned along a frame 133 (as shown, e.g., in FIG. 3) and/or secured via one or more other suitable means.

The induction heater 109 may comprise an electronic oscillator 113, which controls the oscillation intensity of the electric current generated by the induction heating coils. The electronic oscillator 113 may be coupled to one or more ends 115 of the induction heating coils 111.

The induction heating system 100 may comprise a one or more power supplies 117. The one or more power supplies 117 may be in electronic communication with one or more components of the induction heating system 100 such as, e.g., the induction heater 109. The power supply 117 may be configured to supply power to the electronic oscillator 113, causing the electronic oscillator 113 to pass a high frequency alternating current through the one or more induction heating coils 111, generating an electromagnetic field around the one or more induction heating coils 111. According to various embodiments, the induction heating system 100 may comprise one or more water-cooled power leads configured to provide flexible connection of induction power to the one or more induction heating coils 111 and/or to provide a path and connection for cooling water. According to various embodiments, one or more components of the induction heating system 100 may be coupled to one or more cooling systems for cooling one or more components of the induction heating system 100 (e.g., the one or more induction heating coils 111). The one or more cooling systems may comprise fan systems, water cooling systems (e.g., closed pressurized water cooling systems) and/or other suitable types of cooling systems.

According to various embodiments, the electromagnetic field is configured to heat the pipe 103 through Joule heating, imparting thermal energy to the asphalt 101 used in the manufacture of roofing within the opening 105 of the pipe 103, heating the asphalt 101 used in the manufacture of roofing to a desired temperature.

According to various embodiments, the induction heating system 100 may comprise a thermocouple 119 located adjacent to or within the pipe 103. The thermocouple 119 may be configured to measure a temperature of the asphalt 101 used in the manufacture of roofing. It is noted, however, that one or more other sensors configured to sense a temperature of the asphalt 101 used in the manufacture of roofing may be implemented in conjunction with the induction heating system 100 while maintaining the spirit and functionality of the present disclosure.

According to various embodiment, the induction heater 109 may comprise one or more computing devices 121. According to various embodiments, the computing device 121 may comprise a processor 123 and/or a memory 125. The memory 125 may be configured to store programming instructions that, when executed by the processor 123, are configured to cause the processor 123 to perform one or more tasks such as, e.g., thermostatically adjusting a power output of the power supply 117, based on a temperature of the asphalt 101 used in the manufacture of roofing, in order to adjust the temperature of the asphalt 101 used in the manufacture of roofing.

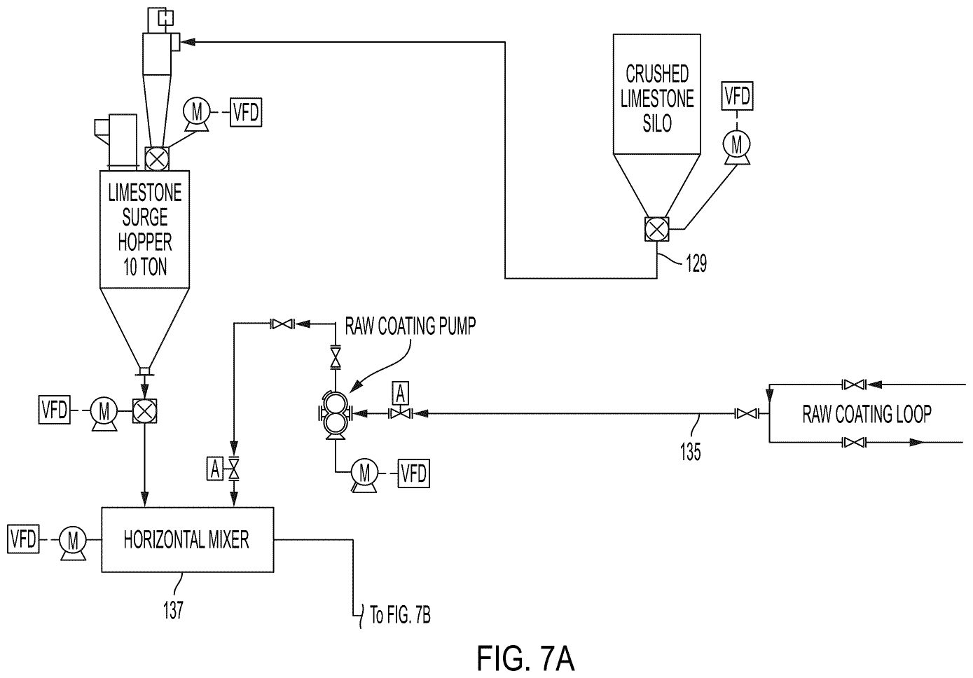

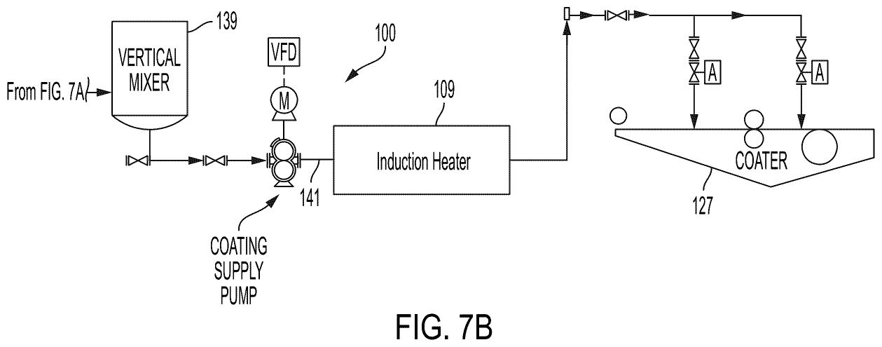

According to various embodiments, the induction heating system 100 may comprise an asphalt applicator 127 (e.g., an asphalt coater), as shown, e.g., in FIGS. 7A-7B. The asphalt applicator 127 may be configured to apply the asphalt 101, used in the manufacture of roofing, to one or more roofing materials, such as, for example, limestone 129 and coating (processed asphalt) 135. According to various embodiments, the asphalt applicator 127 may be positioned along the pipe 103, downstream from the induction heater 109 (as shown, e.g., in FIGS. 7A-7B). It is noted, however, that the asphalt applicator 127 may be positioned elsewhere along the induction heating system 100 while maintaining the spirit and functionality of the present disclosure.

According to various embodiments, the limestone 129 and coating 135 may be mixed (e.g., in one or more horizontal mixers 137, in one or more vertical mixers 139, and/or via one or more other suitable mixing devices, systems, and/or methods) upstream of the induction heater 109 and pass through it as a slurry 141.

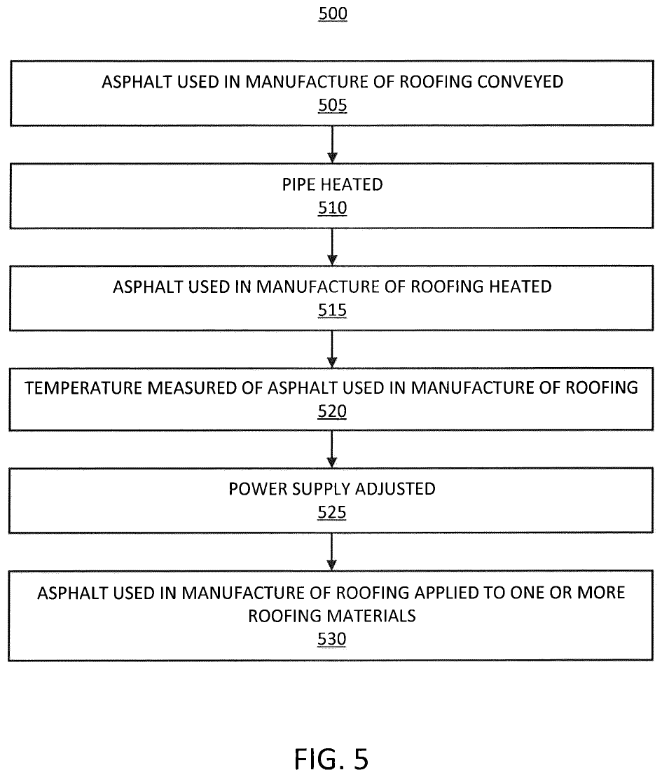

Referring now to FIG. 5, a method 500 for heating asphalt used in the manufacture of roofing is illustratively depicted, in accordance with an exemplary embodiment of the present disclosure.

At 505, asphalt used in the manufacture of roofing is conveyed, using an asphalt conveyance system, through a pipe. The pipe may comprise an opening configured to facilitate movement of the asphalt used in the manufacture of roofing through the opening. According to various embodiments, the asphalt used in the manufacture of roofing may comprise asphalt, polymer, acid modifiers; limestone, asphalt blending modifiers such as petroleum resin and wax, and/or other suitable materials for manufacturing the asphalt used in the manufacture of roofing.

At 510, the pipe is heated using an induction heater.

The induction heater may comprise one or more (e.g., a plurality) induction heating coils. Each of the induction heating coils may be positioned around a circumference of the pipe. According to various embodiments, the one or more induction heating coils may comprise between four and eight induction heating coils. It is noted, however, that greater or fewer numbers of induction heating coils may be used, while maintaining the spirit and functionality of the present disclosure.

The induction heater may comprise an electronic, oscillator coupled to ends of the one or more induction heating coils, and/or one or more power supplies. The power supply may be configured to supply power to the electronic oscillator, causing the electronic oscillator to pass a high frequency alternating current through the one or more induction heating coils, generating an electromagnetic field around the plurality of induction heating coils. The electromagnetic field may be configured to heat the pipe through Joule heating.

At 515, the asphalt used in the manufacture of roofing is heated to a desired temperature by imparting thermal energy from the pipe to the asphalt used in the manufacture of roofing within the opening of the pipe. According to various embodiments, heating the asphalt used in the manufacture of roofing may comprise heating the asphalt used in the manufacture of roofing at least 3° Fahrenheit. According to various embodiments, heating the asphalt used in the manufacture of roofing may comprise heating the asphalt used in the manufacture of roofing approximately 20° Fahrenheit. According to various embodiments, heating the asphalt used in the manufacture of roofing may comprise heating the asphalt used in the manufacture of roofing to approximately 350° Fahrenheit to 460° Fahrenheit. It is noted, however, that, according to various embodiments, the induction heater may be configured to heat the asphalt used in the manufacture of roofing by greater or fewer degrees Fahrenheit and/or to a temperature greater than 460° Fahrenheit and/or less than 350° Fahrenheit.

At 520, a temperature of the asphalt used in the manufacture of roofing is measured using a thermocouple. According to various embodiments, the temperature of the asphalt used in the manufacture of roofing may be measured before, during, and/or after heating the asphalt used in the manufacture of roofing.

According to various embodiment, the induction heater may comprise one or more computing devices. According to various embodiments, the computing device may comprise a processor and/or a memory. The memory may be configured to store programming instructions that, when executed by the processor, are configured to cause the processor to perform one or more tasks. At 525, using the processor, a power output of the power supply is adjusted, based on the temperature of the asphalt used in the manufacture of roofing, in order to adjust the temperature of the asphalt used in the manufacture of roofing.

At 530, the asphalt used in the manufacture of roofing is applied to one or more roofing materials using an asphalt applicator. According to various embodiments, the asphalt applicator is positioned along the pipe, downstream from the induction heater. It is noted, however, that the asphalt applicator may be positioned elsewhere along the induction heating system while maintaining the spirit and functionality of the present disclosure.

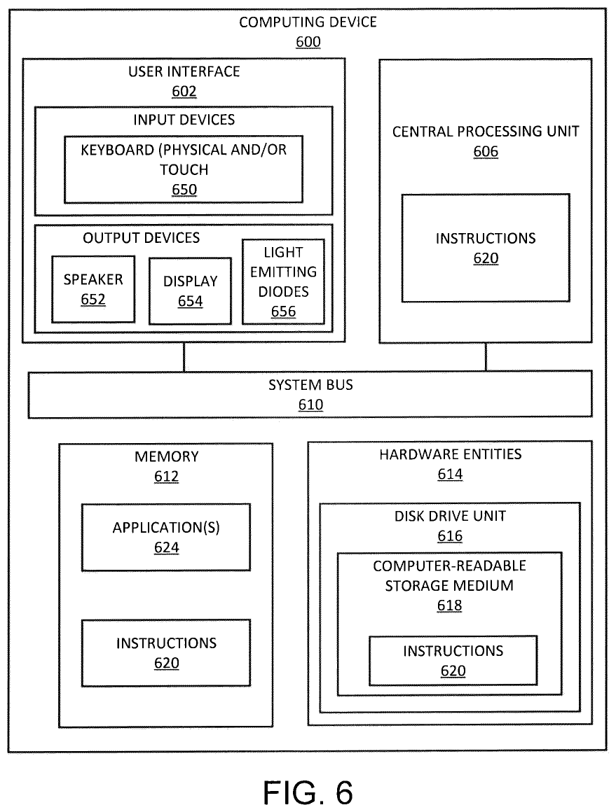

Referring now to FIG. 6, an illustration of an example architecture for a computing device 600 is provided. The computing device 121 of FIG. 1 maybe the same as or similar to computing device 600. As such, the discussion of computing device 600 is sufficient for understanding the computing device 121 of FIG. 1, for example.

Computing device 600 may comprise more or less components than those shown in FIG. 1. The hardware architecture of FIG. 6 represents one example implementation of a representative computing device configured to one or more methods and means for heating asphalt used in the manufacture of roofing, as described herein. As such, the computing device 600 of FIG. 6 implements at least a portion of the method(s) described herein (for example, method 500 of FIG. 5).

Some or all components of the computing device 600 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 6, the computing device 600 may comprise a user interface 602, a Central Processing Unit (“CPU”) 606, a system bus 610, a memory 612 connected to and accessible by other portions of computing device 600 through system bus 610, and hardware entities 614 connected to system bus 610. The user interface can include input devices and output devices, which facilitate user-software interactions for controlling operations of the computing device 600. The input devices include, but are not limited to, a physical and/or touch keyboard 650. The input devices can be connected to the computing device 600 via a wired or wireless connection (e.g., a Bluetooth® connection). The output devices include, but are not limited to, a speaker 652, a display 654, and/or light emitting diodes 656.

At least some of the hardware entities 614 may be configured to perform actions involving access to and use of memory 612, which can be a Random Access Memory (RAM), a disk driver and/or a Compact Disc Read Only Memory (CD-ROM), among other suitable memory types. Hardware entities 614 can include a disk drive unit 616 comprising a computer-readable storage medium 618 on which is stored one or more sets of instructions 620 (e.g., programming instructions such as, but not limited to, software code) configured to implement one or more of the methodologies, procedures, or functions described herein. The instructions 620 may also reside, completely or at least partially, within the memory 612 and/or within the CPU 606 during execution thereof by the computing device 600. The memory 612 and the CPU 606 also may constitute machine-readable media. The term “machine-readable media”, as used here, refers to a single medium or multiple media (e.g., a centralized or distributed database, and/or associated caches and servers) that store the one or more sets of instructions 620. The term “machine-readable media”, as used here, also refers to any medium that is capable of storing, encoding or carrying a set of instructions 620 for execution by the computing device 600 and that cause the computing device 600 to perform any one or more of the methodologies of the present disclosure.

The effects obtainable in the present disclosure are not limited to the above-mentioned effects, and other effects not mentioned herein may be clearly understood by those of ordinary skill in the art to which the present disclosure belongs from the above description.

The present disclosure described above may be implemented as computer-readable code on a medium in which a program is recorded. The computer-readable medium comprises all types of recording devices in which data readable by a computer system is stored. Examples of the computer-readable medium include a hard disk drive (HDD), a solid state drive (SSD), a silicon disk drive (SDD), a ROM, a RAM, a CD-ROM, a magnetic tape, a floppy disk, an optical data storage device, etc.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents. The features and functions described above, as well as alternatives, may be combined into many other different systems or applications. Various alternatives, modifications, variations or improvements may be made by those skilled in the art, each of which is also intended to be encompassed by the disclosed embodiments.

What is claimed is:

1. An induction heating system for heating asphalt used in the manufacture of roofing, comprising:
a pipe comprising an opening configured to facilitate movement of an asphalt used in the manufacture of roofing through the opening;
an asphalt conveyance system configured to convey the asphalt used in the manufacture of roofing through the pipe; and
an induction heater, comprising:
a plurality of induction heating coils, wherein each of the plurality of induction heating coils is positioned around a circumference of the pipe;
an electronic oscillator coupled to ends of the plurality of induction heating coils; and
a power supply configured to supply power to the electronic oscillator, causing the electronic oscillator to pass a high frequency alternating current through the plurality of induction heating coils, generating an electromagnetic field around the plurality of induction heating coils,
wherein the electromagnetic field is configured to heat the pipe through Joule heating, imparting thermal energy to the asphalt used in the manufacture of roofing within the opening of the pipe, heating the asphalt used in the manufacture of roofing to a desired temperature.

2. The induction heating system of claim 1, wherein the plurality of induction heating coils comprises between four and eight induction heating coils.

3. The induction heating system of claim 1, wherein the plurality of induction heating coils comprises copper.

4. The induction heating system of claim 1, wherein the asphalt used in the manufacture of roofing comprises one or more of the following: asphalt; polymer; acid modifiers; petroleum resin; wax; and limestone.

5. The induction heating system of claim 1, wherein the induction heater is configured to heat the asphalt used in the manufacture of roofing at least 3° Fahrenheit.

6. The induction heating system of claim 1, wherein the induction heater is configured to heat the asphalt used in the manufacture of roofing to approximately 460° Fahrenheit.

7. The induction heating system of claim 1, further comprising a thermocouple configured to measure a temperature of the asphalt used in the manufacture of roofing.

8. The induction heating system of claim 7, wherein the induction heater further comprises a processor configured to:
based on the temperature of the asphalt used in the manufacture of roofing, thermostatically adjust a power output of the power supply in order to adjust the temperature of the asphalt used in the manufacture of roofing.

9. The induction heating system of claim 1, further comprising an asphalt applicator configured to apply the asphalt used in the manufacture of roofing to one or more roofing materials.

10. The induction heating system of claim 9, wherein the asphalt applicator is positioned along the pipe, downstream from the induction heater.

11. A method for heating asphalt used in the manufacture of roofing, comprising:
conveying, using a asphalt conveyance system, asphalt used in the manufacture of roofing through a pipe,
wherein the pipe comprises an opening configured to facilitate movement of the asphalt used in the manufacture of roofing through the opening;
heating the pipe using an induction heater, wherein:
the induction heater comprises:
a plurality of induction heating coils, wherein each of the plurality of induction heating coils is positioned around a circumference of the pipe;
an electronic oscillator coupled to ends of the plurality of induction heating coils; and
a power supply configured to supply power to the electronic oscillator, causing the electronic oscillator to pass a high frequency alternating current through the plurality of induction heating coils, generating an electromagnetic field around the plurality of induction heating coils, and
the electromagnetic field is configured to heat the pipe through Joule heating; and
heating the asphalt used in the manufacture of roofing to a desired temperature by imparting thermal energy from the pipe to the asphalt used in the manufacture of roofing within the opening of the pipe.

12. The method of claim 11, wherein the plurality of induction heating coils comprises between four and eight induction heating coils.

13. The method of claim 11, wherein the plurality of induction heating coils comprises copper.

14. The method of claim 11, wherein the asphalt used in the manufacture of roofing comprises one or more of the following: asphalt; polymer; acid modifiers; petroleum resin; wax; and limestone.

15. The method of claim 11, wherein heating the asphalt used in the manufacture of roofing comprises heating the asphalt used in the manufacture of roofing at least 3° Fahrenheit.

16. The method of claim 11, wherein heating the asphalt used in the manufacture of roofing comprises heating the asphalt used in the manufacture of roofing to approximately 460° Fahrenheit.

17. The method of claim 11, further comprising measuring a temperature of the asphalt used in the manufacture of roofing using a thermocouple.

18. The method of claim 17, further comprising, using a processor,
based on the temperature of the asphalt used in the manufacture of roofing, thermostatically adjusting a power output of the power supply in order to adjust the temperature of the asphalt used in the manufacture of roofing.

19. The method of claim 11, further comprising applying, using an asphalt applicator, the asphalt used in the manufacture of roofing to one or more roofing materials.

20. The method of claim 19, wherein the asphalt applicator is positioned along the pipe, downstream from the induction heater.
